(19) United States
(12) Patent Application Publication
(10) Pub. No.: US 2014/0359648 A1
(43) Pub. Date: Dec. 4, 2014

(54) HISTORY RECORD AND PROXY RATING FOR MEDIA RECOMMENDATIONS

(71) Applicant: Verizon Patent and Licensing Inc., Basking Ridge, NJ (US)

(72) Inventor: Fenglin Yin, Lexington, MA (US)

(73) Assignee: Verizon Patent and Licensing Inc., Basking Ridge, NJ (US)

(21) Appl. No.: 13/904,085

(22) Filed: May 29, 2013

(51) Int. Cl. H04N 21/442; H04N 21/24

(52) U.S. Cl. CPC H04N 21/44222; H04N 21/2407
USPC 725/14

(57) ABSTRACT

A view history of a user viewing a program is generated. The view history record is used to generate a proxy rating of the program when the user does not assign a rating to the program. The proxy rating is used by a recommendation engine to generate recommendations.

### BACKGROUND

Online video systems mainly compete in price, video quality, and video discovery. Video discovery includes providing users with relevant videos from a library of hundreds or thousands of movies, television shows, and other types of videos. A video discovery system typically incorporates users' tastes into a recommendation engine.

### BRIEF DESCRIPTION OF THE DRAWINGS

FIG. 1A is a diagram illustrating an exemplary environment in which an exemplary embodiment of view history record management and usage may be implemented;

FIG. 1B is a diagram illustrating exemplary elements of network devices depicted in FIG. 1A;

FIGS. 2A and 2B are diagrams illustrating an exemplary messaging flow pertaining to the generation of a view history record;

FIG. 3A is a diagram illustrating an exemplary process of a program agent;

FIG. 3B is a diagram illustrating an exemplary table pertaining to exemplary normalized program viewing data;

FIG. 4 is a diagram illustrating an exemplary messaging flow pertaining to the generation of program recommendations based on a proxy rating;

FIG. 5 is a diagram illustrating exemplary components of a device that may correspond to one or more of the devices depicted in the previous figures; and

FIGS. 6A and 6B are flow diagrams illustrating an exemplary process pertaining to an exemplary embodiment of view history record management, proxy rating, and generation of program recommendations.

### DETAILED DESCRIPTION OF PREFERRED EMBODIMENTS

The following detailed description refers to the accompanying drawings. The same reference numbers in different drawings may identify the same or similar elements.

Users of an online video system may download and store videos for subsequent viewing or may receive video streams for on-demand viewing. In some instances, the users may rate the videos viewed. The online video system may use this information to recommend other videos to the users. In other instances, the users may not rate the videos viewed. For example, the users may be disinterested or do not want to expend any effort or time rating videos.

According to one approach, the online video system may assign a rating to a video, on behalf of a user, when the user views the video but does not provide a rating. For example, the online video system may assign a rating representative of the average rating calculated among other users that provided ratings for the video. However, such an approach does not accurately represent the user's rating and may negatively impact videos to recommend to the user. Indeed, the accuracy of a recommendation engine is determined, at least in part, based on its metadata model collected from the user. There are a multitude of algorithms available to generate recommendations—some are more popular than others in terms of simplicity, scalability, and performance. However, as with any statistical system, most, if not all of these systems fall victim to the property of “garbage in, garbage out.”

The term “program,” as used herein, includes audio and video. By way of example, a program may include a movie, a television show, or other type of audio and video content. Use of the term “program” in this description should also be interpreted based on context. However, as described further below, the concepts described herein are equally applicable to other forms of media, such as books, games, songs, etc.

According to an exemplary embodiment, a program agent generates a view history record. According to an exemplary embodiment, the view history record includes a record identifier, a source identifier, a trajectory identifier, and normalized program viewing data. According to an exemplary embodiment, each of the record identifier, the source identifier, and the trajectory identifier is a hashed number. In this way, the view history record preserves privacy.

According to an exemplary embodiment, the record identifier is unique and is generated based on a globally unique, user identifier; the source identifier is unique and is generated based on a globally unique, device identifier; and the trajectory identifier is unique and is generated based on a globally unique, program identifier.

According to an exemplary embodiment, the normalized program viewing data includes a date, a timestamp, and tracking data indicating what portion of the program is viewed by the user in relation to the date and the timestamp. According to an exemplary implementation, the tracking data is normalized according to a normalized time-length metric (e.g., a segment, etc.). For example, in contrast to indicating a time interval (e.g., 00:00-00:30 to indicate a 30 minute interval), the tracking data indicates a number of segments. The number of segments of a program corresponds to a percentage of the program and has a time order. By way of further example, the tracking data may indicate 0-25. The tracking data may be interpreted as corresponding to the beginning of the program through a twenty-five percent mark of the program. According to this example, the date and timestamp may indicate when the beginning of the program (e.g., at 0) was viewed by the user. As described further below, the tracking data may include a series of dates and timestamps and corresponding number of segments indicating the portion of the program viewed by the user.

According to an exemplary embodiment, the program agent operates on a user device. According to an exemplary implementation, the user device transmits the view history record to a program system. The user device deletes the view history record after the view history record is received by the program system. According to other embodiments, the program agent operates in the program system (e.g., a network device). For example, the network device may be implemented as a program server that transmits (e.g., streams, downloads, etc.) the program to the user device.

The acquisition, storage, and usage of a view history record of a user may be provided as an “opt-in” or “opt-out” service to the user. In this regard, the program service provider may obtain appropriate permissions from the user before providing such a service.

According to an exemplary embodiment, a program system generates a proxy rating based on the view history record. For example, when the user does not provide a rating for a program, the program system generates the proxy rating. The proxy rating is provided to a recommendation engine. According to an exemplary embodiment, a program system includes a recommendation engine to generate program recommendations. According to an exemplary embodiment, the recommendation engine generates program recommendations based on the proxy rating.

While exemplary embodiments provided in this description may be implemented based on the use of a particular network architecture, platform, etc., such implementations are not intended to be restrictive or provide an exhaustive treatment, as such. In other words, the embodiments described herein may be implemented using other suitable network architectures, platforms, etc., which may not be specifically described.

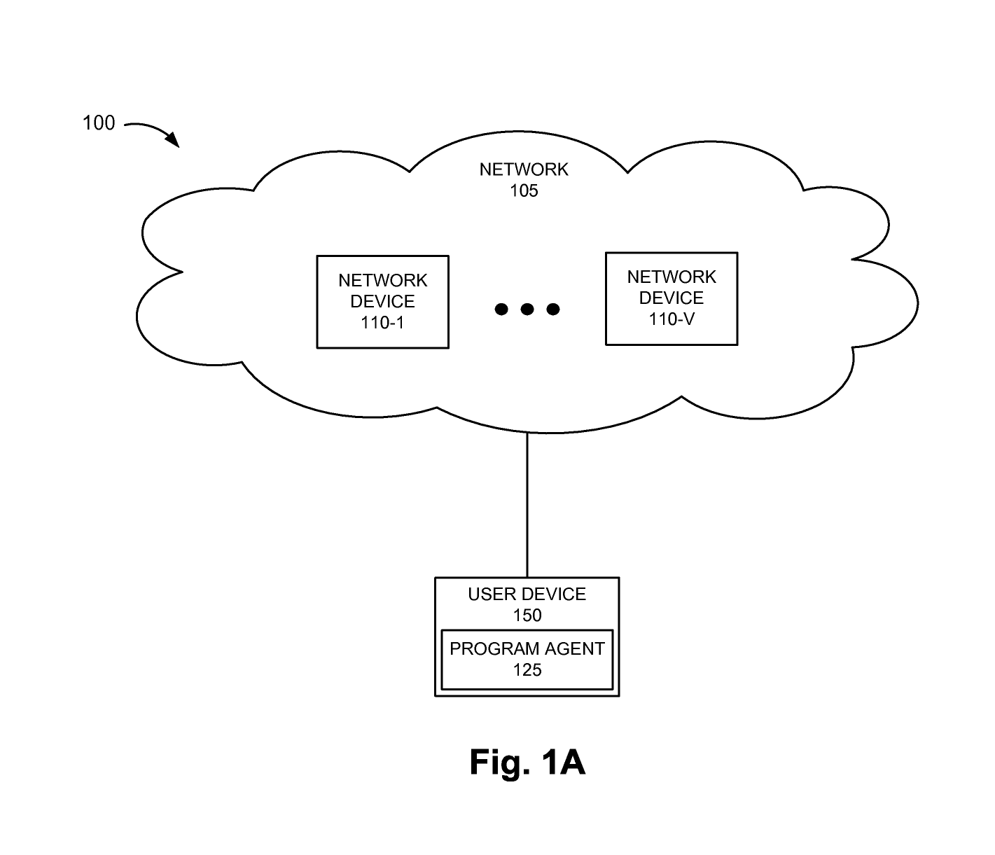

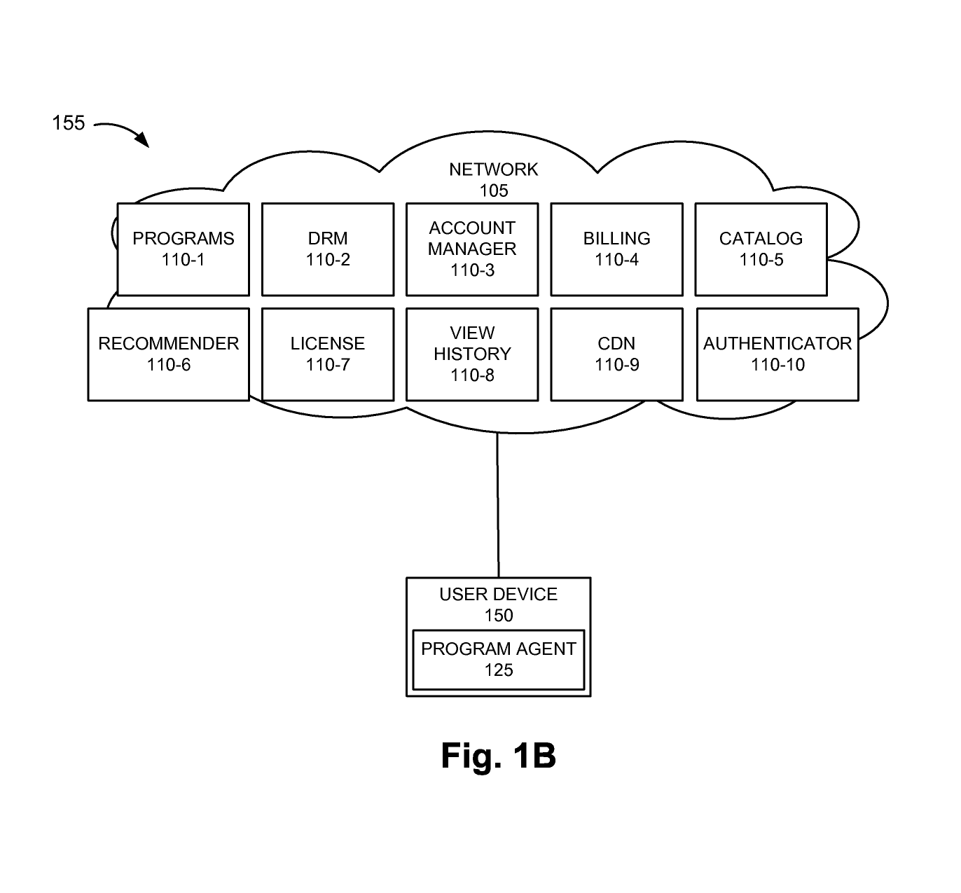

FIG. 1A is a diagram illustrating an exemplary environment in which an exemplary embodiment of view history record management and usage may be implemented. As illustrated, an environment 100 includes a network 105 that includes network devices 110-1 through 110-V (also referred to collectively as network devices 110 or generally as network device 110). Environment 100 also includes a user device 150, which includes a program agent 125.

Environment 100 may be implemented to include wired and/or wireless connections among the devices and network illustrated. A connection may be direct or indirect and may involve intermediary device(s) and/or network(s) not illustrated in FIG. 1A. Additionally, the number and the arrangement of connection between user device 150 and network 105 are exemplary.

Network 105 includes one or multiple networks of one or multiple types. For example, network 105 may include the Internet, a wide area network, a private network, a public network, an intranet, an enterprise network, a local area network, an access network, a packet-switched network, a wired network (e.g., an optical network, a cable network, etc.), a wireless network (e.g., a mobile network, a cellular network, a non-cellular network, etc.), a cloud network, a data network, a computer network, etc. Network 105 may operate according to various protocols, communication standards, platforms, etc.

Network devices 110 include network elements (e.g., logic) that provide a program service. For example, the program service may be a program streaming service, a program download service, or a combination thereof. Network devices 110 may be implemented as, for example, cloud devices, application server devices, web server devices, media devices, program storage devices, security devices, or some combination thereof. At least one network device 110 generates proxy ratings based on view history records. Additionally, at least one network device 110 includes a recommendation engine that generates program recommendations based on proxy ratings of programs.

User device 150 includes an end device. For example, user device 150 may be implemented as a mobile device (e.g., a smartphone, a tablet, a netbook, etc.), a computer (e.g., a desktop computer, a laptop computer, etc.), a television (e.g., a set top box and a television, a smart television, a television and a Roku® device, etc.), a game system, a Web browsing device, or a communication system in a vehicle. Program agent 125 includes software that allows a user to use the program service of network 105. By way of example, program agent 125 may include a program player and a view history manager. The program player includes logic that allows the user to view programs. For example, the program player may be implemented as a media player. The view history manager includes logic to generate view history records, as described herein. Additionally, the view history manager includes logic to manage view history records, as described herein. Program agent 125 may include other logic to, for example, handle licensing, digital rights management (DRM), authentication, streaming, and/or downloading of programs.

According to an exemplary embodiment, program agent 125 generates a view history record in response to a user's consumption of a program via user device 150. User device 150 transmits the view history record to one of network devices 110.

A device (e.g., user device 150, network device 110) may be implemented according to one or multiple network architectures (e.g., a client device, a server device, a peer device, a proxy device, or some combination thereof). Also, according to other embodiments, one or more functions and/or processes described as being performed by a particular device may be performed by a different device, or some combination of devices, which may or may not include the particular device.

FIG. 1B is a diagram illustrating exemplary elements (e.g., logic) of network devices 110 illustrated in FIG. 1A in an exemplary environment 155. As illustrated, network devices 110 includes a programs element 110-1, a DRM element 110-2, an account manager element 110-3, a billing element 110-4, a catalog element 110-5, a recommender element 110-6, a license element 110-7, a view history element 110-8, a content delivery network (CDN) element 110-9, and an authenticator element 110-10.

The number and type of network elements in environment 155 are exemplary. According to other embodiments, environment 155 may include additional network elements, fewer network elements, and/or different network elements than those illustrated in FIG. 1B. For example, network 105 may include various other network elements, such as, one or multiple firewalls, gateways, access points, load balancers, etc.

Programs element 110-1 includes a network element that stores programs. The programs may include programs for purchase, to rent, and/or for free. As previously described, the programs may include movies, television shows, and other types of audio and video content.

DRM element 110-2 includes a network element that provides digital rights management functionality. For example, DRM element 110-2 may manage copying and use of programs. Account manager element 110-3 includes a network element that manages accounts of users pertaining to the program service.

Billing element 110-4 includes a network element that manages billing. For example, billing element 110-4 may monitor and manage purchases of programs, subscription fees, or other monetary compensation that may be implemented with the program service.

Catalog element 110-5 includes a network element that stores metadata pertaining to the programs. For example, catalog element 110-5 may provide various user interfaces to allow users to search for programs, select programs, read metadata (e.g., title, synopsis, cast, year, rating (e.g., PG-13, etc.), user comments, etc.) pertaining to programs, rate programs, and receive program recommendations. Catalog element 110-5 may also provide various user interfaces to allow users to purchase or rent programs.

Recommender element 110-6 includes a network element that generates program recommendations. Recommender element 110-6 may use various parameters to recommend programs. For example, recommender element 110-6 may use user ratings of programs to recommend other programs. Recommender element 110-6 may also use proxy ratings to recommend programs. In addition to user ratings and proxy ratings, recommender element 110-6 may use other parameters, such as popularity, user preferences (e.g., genre, parental rating, freshness, etc.), etc. License element 110-7 includes a network element that manages licenses pertaining to the programs. For example, programs may be associated with various licenses that may restrict the use of the programs in terms of downloading, streaming, time of use, etc.

View history element 110-8 includes a network element that stores view history records pertaining to users. View history element 110-8 may determine whether users have provided ratings for programs. View history element 110-8 generates proxy ratings based on view history records when users have not provided ratings. View history element 110-8 provides proxy ratings to recommender element 110-6. View history element 110-8 is described further below.

CDN element 110-9 includes a network element that manages the delivery of the programs to users. For example, CDN element 110-9 may include streaming servers, load balancers, program servers to download from, etc. Authenticator element 110-10 includes a network element that authenticates users. For example, authenticator element 110-10 may authenticate or authenticate and authorize users during a logging in process.

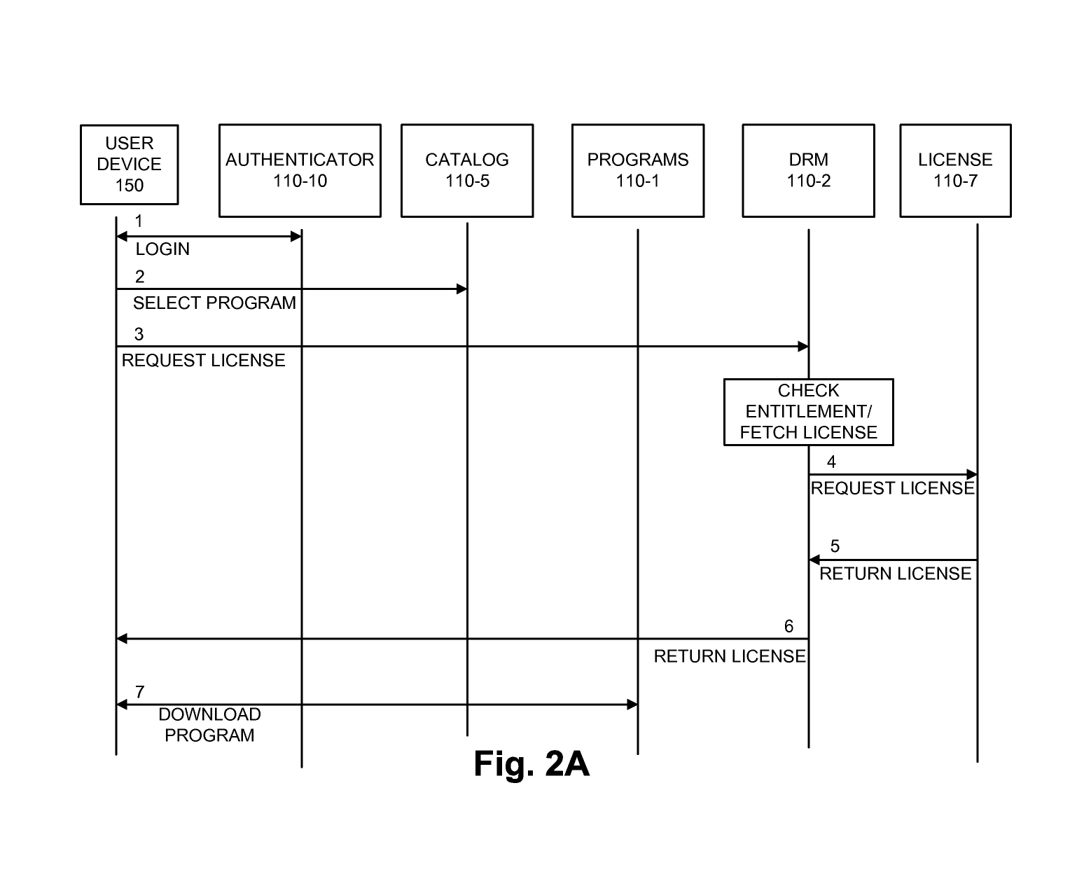

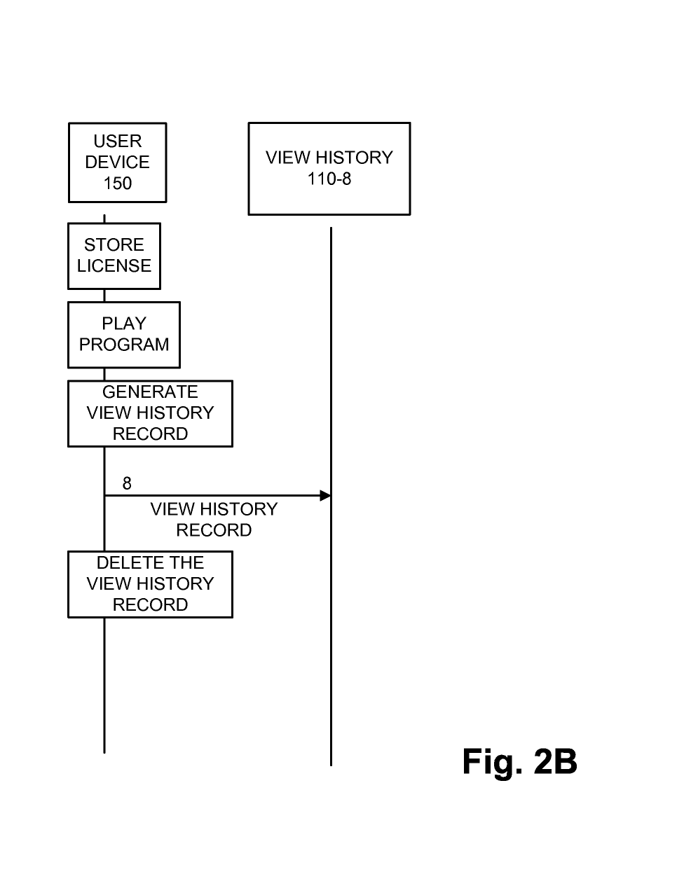

FIGS. 2A and 2B are diagrams illustrating an exemplary messaging flow in which a view history record is generated. The messaging flow is described in relation to user device 150 and elements previously illustrated and described. For the sake of simplicity, messages pertaining to some elements (e.g., billing element 110-4, account manager element 110-3, etc.) have been omitted. According to an exemplary embodiment, user device 150 communicates with one or more of the elements using program agent 125.

Referring to FIG. 2A, assume a user logs in to authenticator element 110-10, via user device 150, to use a program service, as illustrated by message (1). Authenticator element 110-10 successfully authenticates the user. Upon successfully logging in, user device 150 is provided a user interface, by catalog element 110-5, to allow the user to select a program, as illustrated by message (2). According to this exemplary scenario, assume that the user selects a program and wishes to download the program for subsequent viewing. Before downloading the program, user device 150 (e.g., program agent 125) requests a license from DRM element 110-2, as illustrated by message (3). In response to receiving the request, DRM element 110-2 verifies entitlements. For example, DRM element 110-2 may determine whether monies are due before the downloading of the program begins and/or other forms of verifications may be performed. Upon successfully verifying entitlements, DRM element 110-2 requests a license from license element 110-7, as illustrated by message (4). In response to receiving the request, license element 110-7 retrieves the appropriate license and transmits the license to DRM element 110-2, as illustrated by message (5). DRM element 110-2 transmits the license to user device 150, as illustrated in message (6). In response to receiving the license, user device 150 begins to download the program from programs element 110-1, as illustrated by message (7).

Referring to FIG. 2B, user device 150 (e.g., program agent 125) stores the license. According to this exemplary scenario, after completion of the download, the user initiates the playing of the program. User device 150 (e.g., program agent 125) retrieves the locally-stored license, decrypts the license, and verifies entitlements (e.g., verifies if the user is entitled to view the program). According to this example, the user is entitled. User device 150 obtains a decryption key, decrypts the program, and the program beings to play via a media player, which may be included in program agent 125.

According to an exemplary embodiment, at the onset of when the program begins to play, program agent 125 generates a view history record. As previously described, according to an exemplary embodiment, the view history record includes a record identifier, a source identifier, and a trajectory identifier, which are based on a user identifier, a device identifier, and a program identifier, respectively. According to another embodiment, the view history record may not include the device identifier. The user identifier, the device identifier, and the program identifier may be obtained according to well-known methods. For example, program agent 125 may obtain a user identifier during the login, as previously described in relation to message (1). Alternatively, the user identifier may be cached on user device 150. The user identifier may be implemented as any type of string that uniquely identifies the user. For example, the user identifier may include the user's name (portions thereof), a number, and/or other suitable data. A unique user identifier may be established during an on-boarding or subscription process of the program service.

The device identifier may also be stored on user device 150. The device identifier may be implemented as any type of string that uniquely identifies user device 150. For example, the device identifier may correspond to a network address (e.g., a media access control (MAC) address, etc.), an equipment identifier (e.g., a Mobile Equipment Identifier (MEID), an International Mobile Equipment Identity (IMEI), an Electronic Serial Number (ESN), etc.), or other suitable unique identifier (e.g., an Internet Protocol Multimedia Private Identity (IMPI)).

The program identifier may be obtained during the selection or downloading process of the program. Alternatively, the program identifier may be stored on user device 150. For example, metadata associated with the downloaded program includes the program identifier.

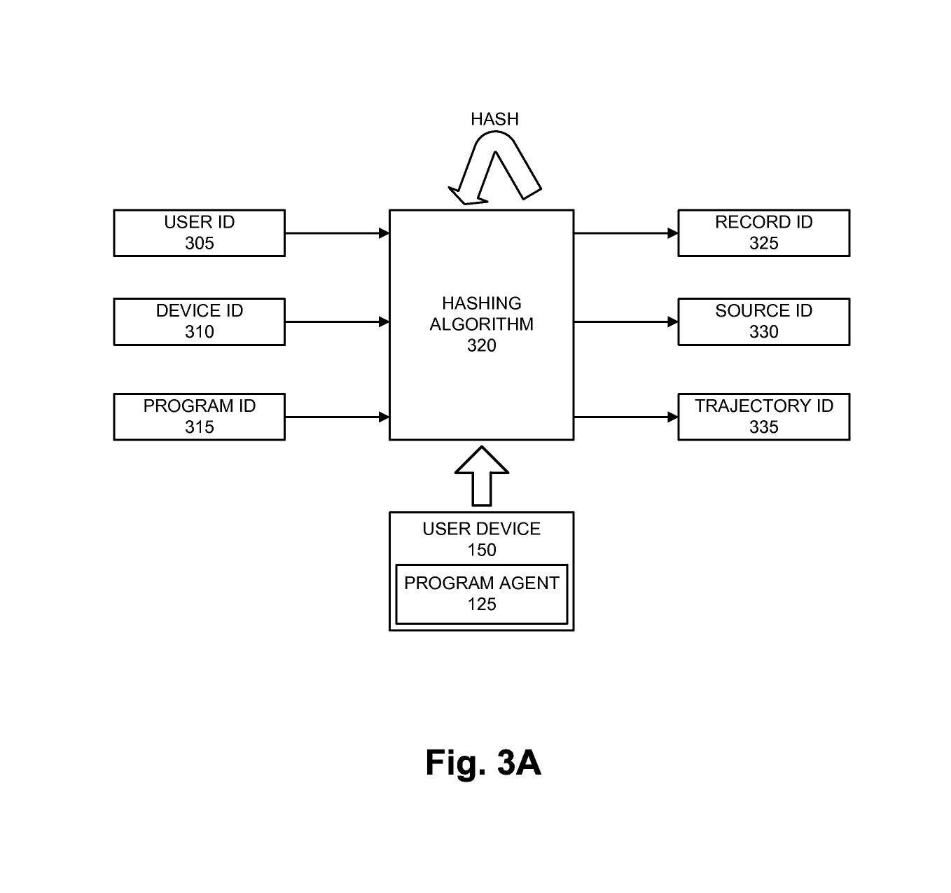

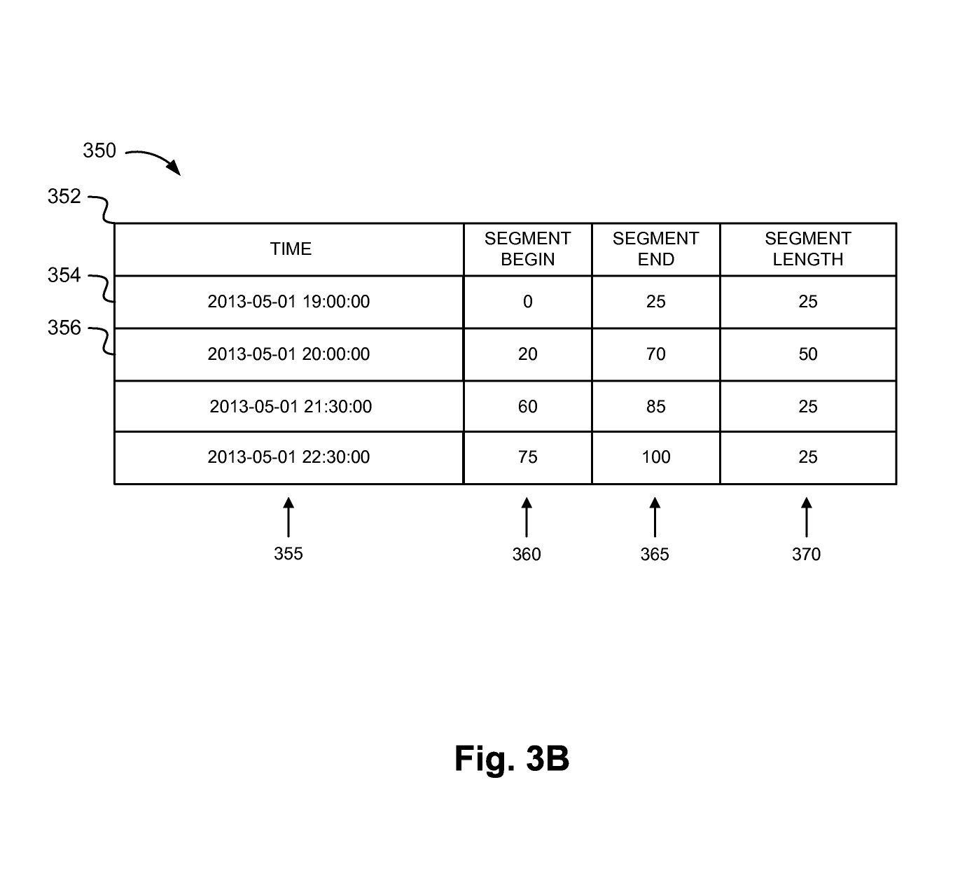

FIGS. 3A and 3B illustrate diagrams pertaining to the generation of a view history record. Referring to FIG. 3A, according to an exemplary embodiment, user device 150 hashes a user identifier 305, a device identifier 310, and a program identifier 315 using a hashing algorithm 320. As a result, a record identifier 325, a source identifier 330, and a trajectory identifier 335 is output. User device 150 may use any suitable hashing algorithm to implement hashing algorithm 320, such as MD5 or SHA-X (e.g., 1, 2). According to other embodiments, security measures in addition to or instead of hashing may be used to preserve privacy, etc. For example, user device 150 may use encryption, etc.

As previously described, according to an exemplary embodiment, user device 150 generates the normalized program viewing data. The normalized program viewing data includes a date and a timestamp pertaining to the user's viewing of the program and tracking data indicating what portion of the program is viewed by the user. The normalized program viewing data may also be hashed. Referring to FIG. 3B, exemplary normalized program viewing data 350 is described. For the sake of description, normalized program viewing data 350 is illustrated in an exemplary table 352. Table 352 includes a time field 355, a segment begin field 360, a segment end field 365, and a segment length field 370. According to other implementations, normalized program viewing data 350 may include additional data, fewer data, and/or different data.

Time field 355 includes data that indicates a date and a timestamp pertaining to the viewing of the program by the user. Segment begin field 360 includes data that indicates a segment from which the program is played in view of the date and timestamp data. Segment end field 365 includes data that indicates a last segment played of the program. Segment length field 370 includes data that indicates the number of segments played in view of the segment begin data and the segment end data.

According to an exemplary embodiment, a normalized program viewing data entry 354 of table 352, which includes fields 355, 360, 365, and 370, may be updated according to a configurable value. By way of example, the configurable value may be implemented as a time period. For example, normalized program viewing data entry 354 may be updated every 10 minutes, 15 minutes, or some other time period. According to an exemplary implementation, during continuous play of the program, program agent 125 may overwrite the data of segment end field 365 and segment length field 370, while leaving time field 355 and segment begin field 360 the same. According to another exemplary implementation, program agent 125 may create a new entry to indicate the latest normalized program viewing data. For example, program agent 125 may store a normalized program viewing data entry 356, as illustrated in FIG. 3B. In that case, program agent 125 stores new data in each of fields 355, 360, 365, and 370.

According to an exemplary embodiment, program agent 125 may create another entry in table 352 in response to user playing events. For example, if the user pauses, stops, rewinds, or fast-forwards the program, program agent 125 creates a new entry (e.g., another row in table 352) in which time field 355 indicates the date and the time indicating the onset of the event (e.g., stop or pause) or the completion of the event (e.g., stops rewinding, stops fast-forwarding). Program agent 125 may also create or update normalized program viewing data in response to the completion of the program.

According to an exemplary embodiment, program agent 125 generates the viewing history record for each viewing session. For example, if the user views a portion of the program on one day and stops, and then begins viewing the program the next day, program agent 125 generates two separate viewing history records. Program agent 125 may determine that another viewing history record is to be generated based on a configurable timeout period. For example, if the user pauses or stops the playing of the program for a duration equivalent to the timeout period, program agent 125 prevents the viewing history record from being updated. Any subsequent playing of the program will cause program agent 125 to generate another viewing history record. Program agent 125 may also consider that the viewing history record is closed based on other events (e.g., when a last segment of the program is played, the user exits program agent 125, etc.).

Referring back to FIG. 2B, when a viewing history record is created and closed (e.g., blocked from further updates), user device 150 may transmit the viewing history record to view history element 110-8. According to an exemplary embodiment, program agent 125 may determine whether the user has rated the program according to a rating system provided by the program service. For example, the user may provide a rating of the program via catalog element 125. If the program agent 125 determines that the user has rated the program, then program agent 125 deletes the view history record and does not transmit the viewing history record to view history element 110-8. However, if the program agent 125 determines that the user has not rated the program, then user device 150 transmits the view history record to view history element 110-8. Additionally, upon receiving confirmation that view history element 110-8 received the view history record, program agent 125 deletes the view history record. In this way, the viewing habits of the user may be kept private on the user device-side.

According to yet another implementation, user device 150 transmits the view history record to view history element 110-8 even when the user has rated the program. For example, as described further below, view history element 110-8 may use view history records pertaining to other programs for calculating a proxy rating pertaining to a program. Thus, even though the user has rated the program, view history element 110-8 may use the view history record when calculating a proxy rating for another program.

As previously described, according to an exemplary embodiment, a proxy rating is calculated based on the view history record. In this way, when a user views the program but does not rate the program, a proxy rating may be calculated. The recommendation engine may calculate program recommendations based on the proxy rating, a further description of which is provided below.

Users may rate programs via catalog element 110-5. As described above, view history element 110-8 stores view history records pertaining to programs viewed by a user. According to an exemplary embodiment, view history element 110-8 may determine whether the user has provided a rating for a program, which may be in addition to or instead of program agent 125 performing this function. For example, catalog element 110-5 may provide unrated program information to view history element 110-8. The unrated program information includes data indicating the program identifiers of programs that have yet to be rated by the users that have viewed programs. For example, the program identifiers may be hashed to generate trajectory identifiers. In this way, view history element 110-8 may compare the trajectory identifiers included in the unrated program information with the trajectory identifiers included in the view history records. View history element 110-8 may select view history records for generating proxy ratings based on these comparisons.

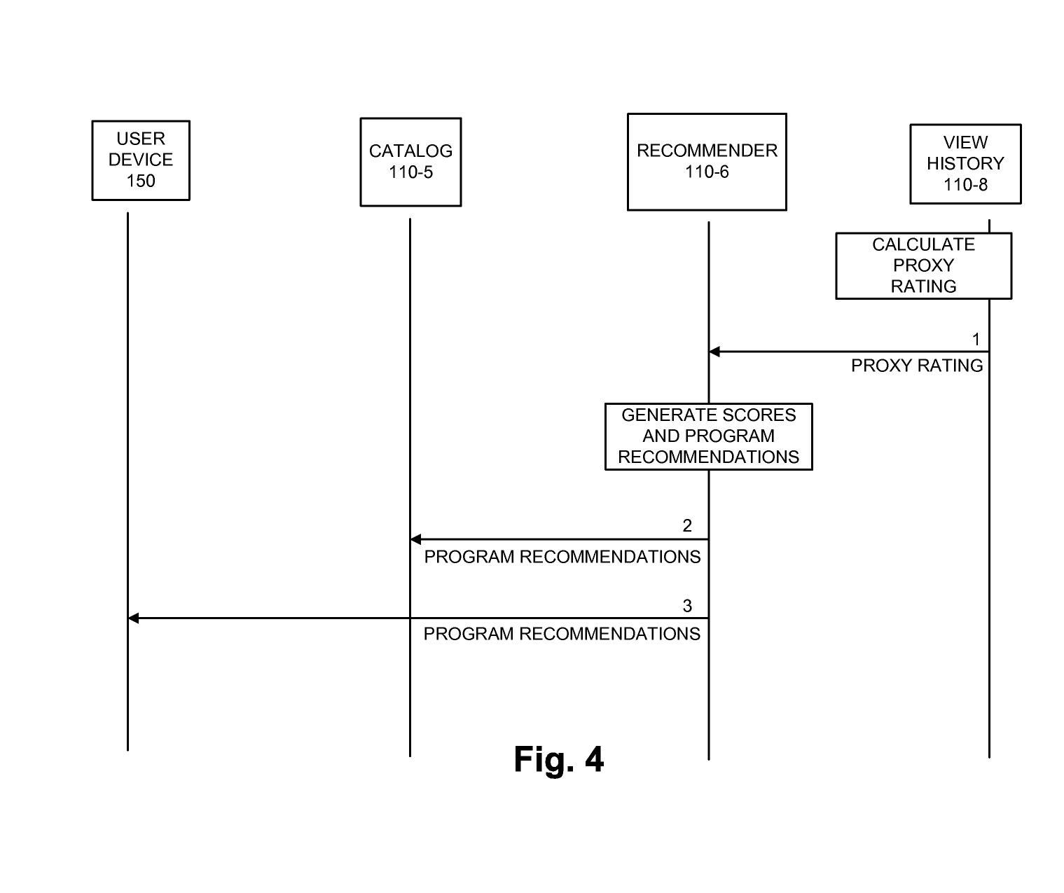

FIG. 4 is a diagram illustrating an exemplary messaging flow pertaining to the generation of program recommendations based on a proxy rating. The messaging flow is described in relation to user device 150 and elements previously illustrated and described. For the sake of simplicity, messages pertaining to some elements (e.g., billing element 110-4, account manager element 110-3, etc.) have been omitted.

As illustrated, view history element 110-8 calculates a proxy rating for a program viewed by the user of user device 150 based on a view history record of the program. According to this example, assume that the user did not provide a rating for the program.

According to an exemplary embodiment, view history element 110-8 calculates the proxy rating based on the following exemplary expressions. For example, the proxy rating is proportional to the normalized viewing data.

R_{u,a}∝(ΣₜTₜ)_{u,a}=a_{u,a}, (1)

in which R_{u,a} is the proxy rating, u indicates the user, a indicates the program, and T indicates a total time of viewing pertaining to the program. T may include one or multiple view history records pertaining to the program. That is, view history element 110-8 may use one or multiple view history records pertaining to the user's viewing of the program.

According to an exemplary implementation, the proxy rating is computed as a round-up integer. For example, the proxy rating may be calculated based on the following exemplary expressions.

R_{u,a}=1, for 0<a_{u,a}≦50 (2)

R_{u,a}=2, for 50<a_{u,a}≦75 (3)

R_{u,a}=3, for 75<a_{u,a}≦100 (4)

R_{u,a}=4, for 100<a_{u,a}≦200 (5)

R_{u,a}=5, for a_{u,a}>200 (6)

Equations (2)-(6) assume a program rating system that includes values, such as one (1), two (2), three (3), four (4), and five (5). These values are assumed to correspond to values available to the user in the rating system provided in the program service. Referring to equation (2), a proxy rating has a value of one (1) if 0<a_{u,a}≦50. That is, if the user views half (e.g., a normalized 50% segment) of the program or less, including not viewing any of the program, viewing history element 110-8 generates a proxy rating of one (1). Similarly, equations (3) and (4) yield a proxy rating based on the amount of the program viewed by the user. For example, if the user views between greater than 50% and 75% segment, the proxy rating is assigned a value of two (2), and so forth. Referring to equation (5), this may occur when the user watches the program more than once. For example, the user may watch the entire program, and then subsequently, watch a portion of the program again or the entire program during another viewing session. Referring to equation (6), this may occur when the user watches the program more than twice. According to other implementations, equations (2)-(6) may use other normalized metrics to indicate which portions of the program the user viewed.

According to an exemplary embodiment, view history element 110-8 calculates the proxy rating based on the equations above. As illustrated in FIG. 4, once the proxy rating is calculated, view history element 110-8 transmits the proxy rating to recommender element 110-6, as illustrated by message (1).

According to another exemplary embodiment, the proxy rating value calculated by view history element 110-8 includes further computation. For example, view history element 110-8 includes analytics to evaluate the manner in which the program is viewed. According to such an embodiment, the proxy rating may not be a round-up integer. That is, for example, a proxy rating may have a value between integer values (e.g., 3.5, 4.2, 2.1, etc.). By way of example, assume that the user viewed the entire program over the course of three days. Based on equation (4), view history element 110-8 initially calculates a proxy rating of three (3). However, according to this embodiment, the analytics may decrement, for example, the proxy rating (e.g., three (3)) due to the user's playing behavior. That is, view history element 110-8 may apply a heuristic that the longer it takes for the user to view the program, the less likely the user is interested in or likes the program. According to an exemplary implementation, the analytics may use view history records pertaining to other programs viewed by the user to apply this heuristic. For example, if a greater percentage of other programs were viewed, in their entirety, within a single viewing session or multiple sessions during a single day, then the analytics applies the heuristic and decrements the proxy rating to a value lower than three (3). On the other hand, if a greater percentage of other programs were viewed, in their entirety, over the course of multiple viewing sessions and multiple days, then the analytics may omit to apply the heuristic.

Conversely, the analytics may increment the proxy rating based on the user's playing behavior. For example, assume that the view history record indicates that the user re-played (i.e., rewound, shuttled backwards, etc.) one or multiple scenes in a movie and the user viewed the entire movie in one viewing session. According to one implementation, view history element 110-8 may generate a proxy rating of three (3). According to another implementation, view history element 110-8 may generate a proxy rating of four (4). For example, the re-played portions of the movie may be interpreted as greater than 100. In either case, the analytics may increment the proxy rating to a greater value than three (3) or four (4) due to the user's playing behavior. That is, view history element 110-8 may apply a heuristic that the replaying of a scene provides a basis that the user's is interested in the program. In other words, the user may ascribe a particular scene as a “favorite part,” which further enhances the likelihood that the user especially likes the program. According to an exemplary implementation, the analytics may use view history records pertaining to other programs viewed by the user to ascertain a comparative and determine whether this playing behavior is customary or not. If it is not customary, the analytics may increment the proxy rating. If it is customary, the analytics may not increment the proxy rating value or may increment the proxy rating, but to a lesser value relative to when it is not customary, depending on the result of the comparative and various factors (e.g., the number of rewinds, whether there are multiple rewinds, whether there are multiple rewinds of the same scene, etc.).

Other variations to the above examples may be extrapolated and may be implemented by the analytics. For example, if the view history record includes numerous pauses, such behavior may be indicative that the user was disinterested, particularly if this does not correspond to past behavior. Additionally, there may be situations that the user fast-forwards the program. This type of user behavior may be indicative that the user is disinterested in the program. For example, the user may view half of the program and then decide to skip to the ending of the program. The analytics may decrement the proxy rating based on this behavior, which is indicated in the view history record.

The value or the degree in which a proxy rating is incremented or decremented is configurable by the program service provider. The increment or decrement may be based on specifics of the user playing behavior. For example, according to a rewind scenario, the value may be based on factors such as, how many times did the user rewind the program to see a particular scene again, how many scenes did the user view again, the length of the scene (e.g., lasted only 10 seconds versus 10 minutes), the position of the scene (e.g., the ending of the movie, the first scene in the movie, etc.), etc. In this regard, for example, the greater the number of times the user rewinds, the greater the length of the scene, etc., may yield a larger increment value relative to a fewer number of times the user rewinds, etc.

Additionally, or alternatively, the value in which the proxy rating is incremented or decremented may be based on a contrast value. For example, the analytics may generate a contrast value based on the comparison of the user playing behavior included in the view history record and view history records pertaining to other programs. Thus, for example, according to a scenario in which the user infrequently exhibits a rewind behavior, the contrast value may be higher relative to a scenario in which the user frequently exhibits a rewind behavior. Thus, according to this example, the higher the contrast value, the larger the value by which the proxy rating is incremented.

The analytics may use context information to discount alternate explanations for the user's rewind behavior. The context information may include date, time, and device used. For example, if the user was viewing the program late at night on a television located in the user's bedroom, it may be less likely the user rewound the program due to an interruption. Additionally, other context information may be obtained, such as location of the user. The analytics may consider other types of information, such as the popularity of the scene amongst other users, attention in the news media relating to the scene, or other sources (e.g., social media, blogs, social networking sites, etc.) that provide an assessment of the scene (e.g., whether the scene is a “stand-out” scene) in the program, etc.

As set forth above, according an exemplary embodiment, a proxy rating is generated based on the view history record. The view history record includes data indicating the portions of a program viewed by the user. According to an exemplary embodiment, view history element 110-8 applies a weighting system when generating a proxy rating. For example, view history element 110-8 applies a particular weight to the portion of the program viewed. By way of further example, assume that the user views only half of the program. Furthermore, assume in one case the user views 35% of the beginning of a movie and then fast-forwards to the last 15% of the movie (i.e., the ending); and in another case, the user views the first half of the movie (i.e., from the beginning of the move to a midway point). While in each case, the user views 50% of the movie, the analytics may calculate a different proxy rating given the different portions of the movie viewed by the user. For example, the analytics may assign a greater weight to the ending of the movie then the middle portion of the movie, the beginning of the movie, or both. The analytics may apply heuristics that form a basis of the weighting system. For example, with regard to the scenario described, a greater weight may be applied to the end of the movie since a user that is not interested in the ending of the movie is indicative of an individual that dislikes the movie to a greater degree relative to a user that is interested in the outcome of the movie. Thus, according to this example, the analytics may increment the proxy rating relating to the user that views the ending.

Referring to FIG. 4, as previously mentioned, view history element 110-8 transmits the proxy rating to recommender element 110-6. Recommender element 110-6 generates a score for programs based on the proxy rating. For example, recommender element 110-6 may use the following exemplary expression:

S_{u,a}=f(R_{u,a}, . . . ), (7)

in which S_{u,a} indicates a score for program a for user u. The score is calculated based on the function f that uses the proxy rating R_{u,a}. The function f may include other parameters, which may be, for example proprietary, well-known, etc., in accordance with the recommendation algorithm used. As previously described, for instances in which the user does not provide a rating of a program viewed, the proxy rating may be used as a replacement parameter. Based on the scoring of programs, recommender element 110-6 generates program recommendations that are believed to interest the user.

As further illustrated, recommender element 110-6 transmits the program recommendations to catalog element 110-5, as illustrated by message (2). In this way, when the user logs in to the program service and begins to search or select programs to view, catalog element 110-5 provides the program recommendations to the user via a user interface. Additionally, or alternatively, recommender element 110-6 may transmit the program recommendations to user device 150, as illustrated by message (3). For example, program recommendations may be pushed to user device 150 via e-mails, text messages, or other viable communication paths (e.g., program agent 125, etc.).

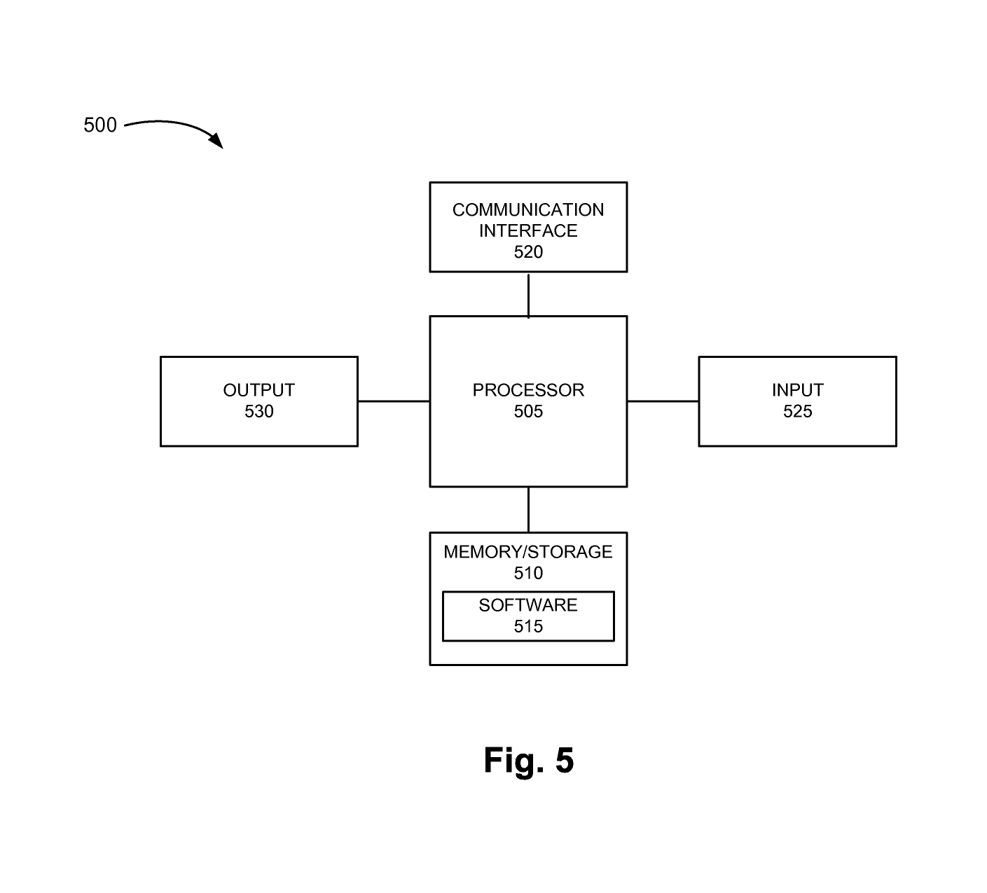

FIG. 5 is a diagram illustrating exemplary components of a device 500 that may correspond to one or more of the devices depicted in the previous figures. For example, device 500 may correspond to components of user device 150, network device 110, and/or a network element. As illustrated, according to an exemplary embodiment, device 500 includes a processor 505, memory/storage 510, software 515, a communication interface 520, an input 525, and an output 530. According to other embodiments, device 500 may include fewer components, additional components, different components, and/or a different arrangement of components than those illustrated in FIG. 5 and described herein.

Processor 505 includes one or multiple processors, microprocessors, data processors, co-processors, multi-core processors, application specific integrated circuits (ASICs), controllers, programmable logic devices, chipsets, field programmable gate arrays (FPGAs), system on chips (SoCs), programmable logic devices (PLSs), microcontrollers, application specific instruction-set processors (ASIPs), central processing units (CPUs), or some other component that interprets and/or executes instructions and/or data. Processor 505 may be implemented as hardware (e.g., a microprocessor, etc.) or a combination of hardware and software (e.g., a SoC, an ASIC, etc.). Processor 505 may include one or multiple memories (e.g., memory/storage 510), etc.

Processor 505 may control the overall operation, or a portion of operation(s) performed by device 500. Processor 505 may perform one or multiple operations based on an operating system and/or various applications or programs (e.g., software 515). Processor 505 may access instructions from memory/storage 510, from other components of device 500, and/or from a source external to device 500 (e.g., another device, a network, etc.).

Memory/storage 510 includes one or multiple memories and/or one or multiple other types of storage mediums. For example, memory/storage 510 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other type of memory. Memory/storage 510 may include a hard disk (e.g., a magnetic disk, an optical disk, a magneto-optic disk, a solid state disk, etc.) and a corresponding drive. Memory/storage 510 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 510 may include drives for reading from and writing to the storage medium.

Memory/storage 510 may be external to and/or removable from device 500, such as, for example, a Universal Serial Bus (USB) memory stick, a dongle, a hard disk, mass storage, off-line storage, or some other type of storage medium (e.g., a compact disk (CD), a digital versatile disk (DVD), a Blu-Ray® disk (BD), etc.). Memory/storage 510 may store data, software, and/or instructions related to the operation of device 500

Software 515 includes an application or a program that provides a function and/or a process. Software 515 may include firmware. For example, with reference to program agent 125 and view history element 110-8, software 515 may include an application that, when executed by processor 505, provides the functions of program agent 125 and view history element 110-8, as described herein.

Communication interface 520 permits device 500 to communicate with other devices, networks, systems, and the like. Communication interface 520 includes a wireless interface and/or a wired interface. The wireless interface and the wired interface include, among other components, a transmitter and a receiver. Communication interface 520 may also support various communication protocols, communication standards, etc.

Input 525 provides an input into device 500. For example, input 525 may include a keyboard, a keypad, a touchscreen, a touch pad, a touchless screen, a mouse, an input port, a button, a switch, a microphone, a knob, and/or some other type of input.

Output 530 provides an output from device 500. For example, output 530 may include a display, a speaker, a light (e.g., light emitting diode(s), etc.), an output port, a vibratory mechanism, and/or some other type of output.

Device 500 may perform a function or a process in response to processor 505 executing software instructions stored by memory/storage 510. For example, the software instructions may be stored in memory/storage 510 based on a loading from another memory/storage 510 of device 500 or stored into memory/storage 510 based on a loading from another device via communication interface 520. The software instructions stored in memory/storage 510 may cause processor 505 to perform processes described herein. Alternatively, according to another implementation, device 500 may perform a process or a function based on the execution of hardware (e.g., processor 505, etc.).

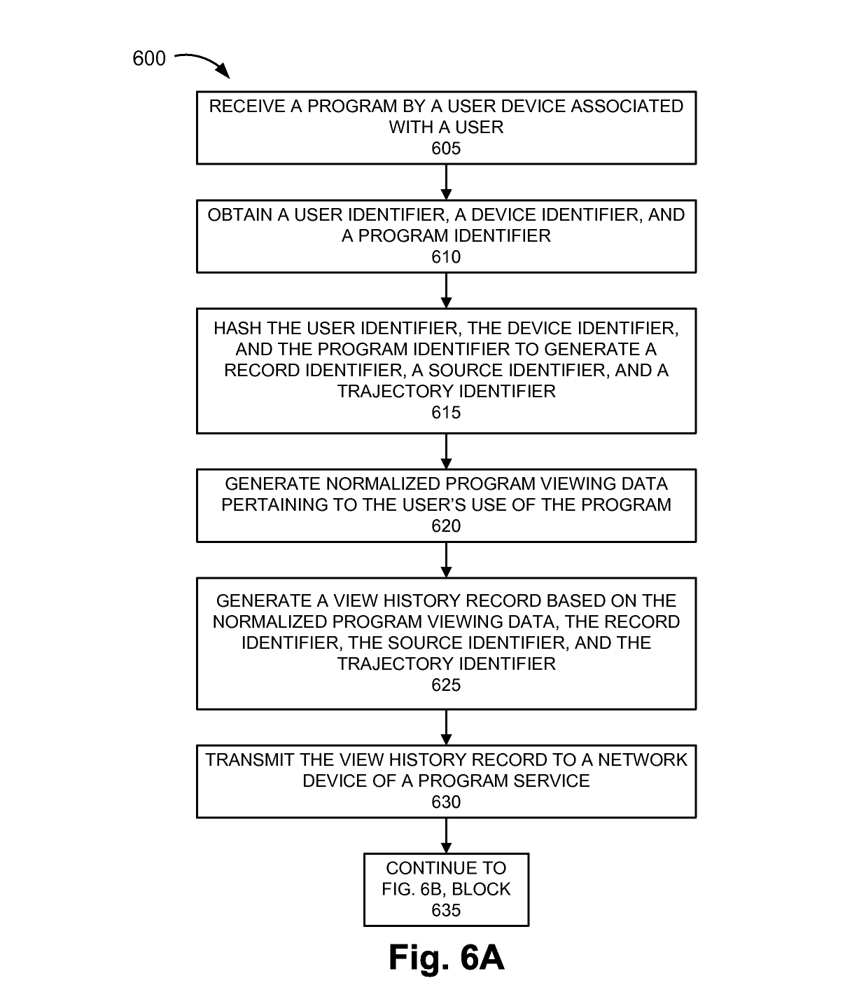

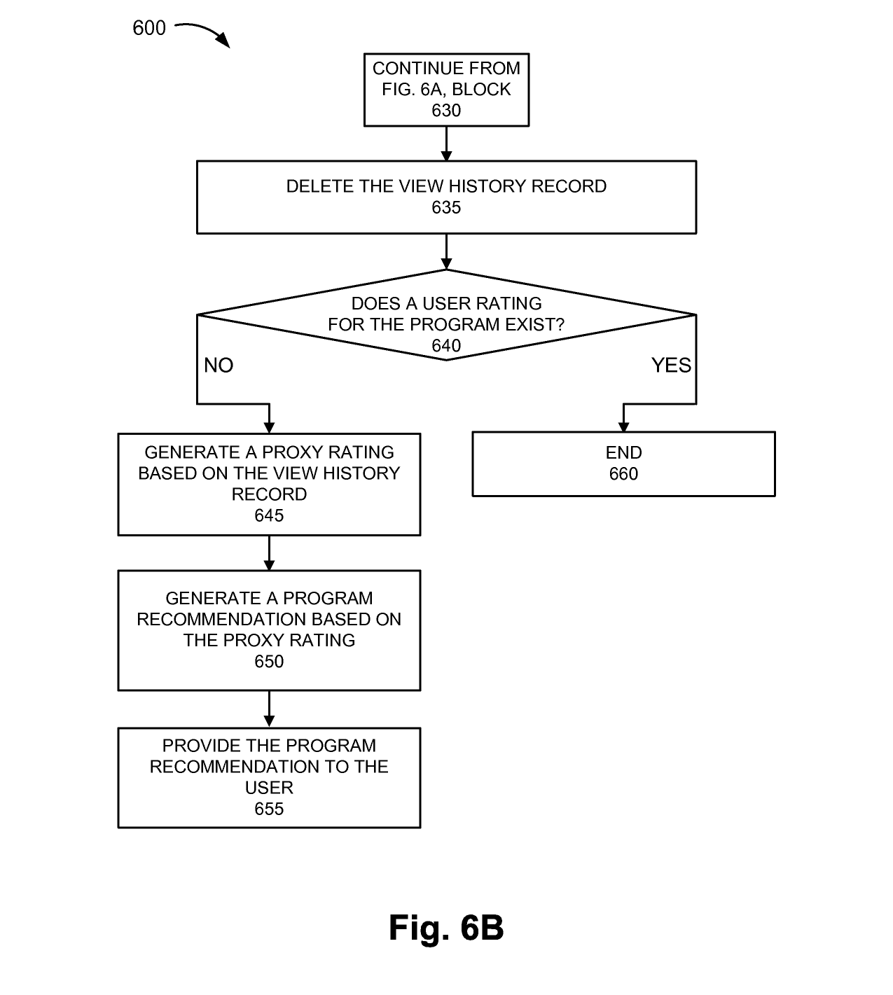

FIGS. 6A and 6B are flow diagrams illustrating an exemplary process pertaining to an exemplary embodiment of view history record management, proxy rating, and generation of program recommendations. A step described in process 600 is performed by one of the devices or elements implemented by one of the devices illustrated in the previous figures. For example, the device may correspond to user device 150 or network device 110. The description of process 600 refers to previous figures.

Referring to FIG. 6A, in block 605, process 600 begins with receiving a program by a user device associated with a user. For example, as previously described, a user obtains a program, via user device 150, from a program service. For example, the program service provides the program using programs element 110-1 and CDN element 110-9. According to an exemplary implementation, the program is downloaded to user device 150. According to another exemplary implementation, the program is streamed to user device 150.

In block 610, a user identifier, a device identifier, and a program identifier is obtained. For example, as previously described, a user identifier that identifies the user of user device 150, a device identifier that identifies user device 150, and a program identifier that identifies the program is obtained. For example, an identifier may be obtained during a logging in process, when the user selects the program, from a cache on user device 150, etc.

In block 615, the user identifier, the device identifier, and the program identifier are hashed to generate a record identifier, a source identifier, and a trajectory identifier. For example, as previously described, program agent 125 uses hashing algorithm 320 to hash the user identifier, the device identifier, and the program identifier to generate a record identifier, a source identifier, and a trajectory identifier. Program agent 125 may operate on user device 150 or network device 110 (e.g., programs element 110-1, CDN element 110-9).

In block 620, normalized program viewing data, pertaining to the user's viewing of the program, is generated. For example, as previously described, program agent 125 generates normalized program viewing data 350 corresponding to the user's viewing behavior of the program. According to an exemplary implementation, program agent 125 may create a new entry of normalized program viewing data in response to user playing events (e.g., pause, stop, etc.).

In block 625, a view history record is generated based on the normalized program viewing data, the record identifier, the source identifier, and the trajectory identifier. For example, as previously described, program agent 125 generates the view history record based on the record identifier, the source identifier, the trajectory identifier, and normalized program viewing data 350. Program agent 125 determines when to close the view history record from further updates.

In block 630, the view history record is transmitted to a network device of a program service. For example, as previously described, user device 150 transmits the view history record to view history element 110-8. Alternatively, according to another implementation, network device 110 (e.g., programs element 110-1, CDN element 110-9) transmits the view history record to view history element 110-8. According to an exemplary scenario, it may be assumed that the user did not rate the program.

Referring to FIG. 6B, in block 635, the view history record is deleted. For example, as previously described, user device 150 deletes the view history record. Alternatively, network device 110 deletes the view history record. The view history record is deleted after receiving confirmation that the view history record is received by view history element 110-8.

In block 640, it is determined whether a user rating for the program exists. For example, as previously described, view history element 110-8 receives unrated program information from catalog element 110-5. View history element 110-8 compares the trajectory identifier included in the view history record to trajectory identifiers included in unrated program information, which is stored by view history element 110-8. View history element 110-8 may be configured to wait a threshold time period before generating a proxy rating so as to afford the user sufficient time to provide a rating for the program (e.g., to catalog element 110-5). Alternatively, view history element 110-8 may generate the proxy rating without a waiting period. Catalog element 110-5 may update view history element 110-8, recommender 110-6, or both as to the existence of a rating pertaining to a program if the user provides a rating subsequent to the generation of proxy rating. Under such circumstances, recommender element 110-6 may use the rating as a basis for generating subsequent program recommendations.

If it is determined that a user rating does not exist for the program (block 640—NO), then a proxy rating based on the view history record is generated (block 645). For example, if view history element 110-8 identifies a match between the trajectory identifier included in the view history record and a trajectory identifier included in the unrated program information, view history element 110-8 generates a proxy rating, as previously described. For example, view history element 110-8 calculates a proxy rating based on one of equations (2)-(6). Additionally, for example, the analytics of view history element 110-8 may increment or decrement the proxy rating according to the heuristics previously described.

In block 650, a program recommendation is generated based on the proxy rating. For example, as previously described, view history element 110-8 transmits the proxy rating to recommender element 110-6. Recommender element 110-6 generates program recommendations for the user based on the proxy rating. For example, as previously described, recommender element 110-6 may use various types of algorithms, which make use of various factors/parameters including the proxy rating, to generate program recommendations.

In block 655, the program recommendation is provided to the user. For example, recommender element 110-6 transmits the program recommendations to catalog element 110-5. Additionally, or alternatively, recommender element 110-6 transmits the program recommendations to user device 150. In either case, the program recommendations are made available to the user.

If it is determined that a user rating does exist for the program (block 640—YES), then process 600 ends. For example, view history element 110-8 may continue to store the view history record for use in calculating a proxy rating for another program viewed by the user.

Although FIGS. 6A and 6B illustrate an exemplary process 600 pertaining to the generation of a view history record, a proxy rating, and program recommendations, according to other implementations, process 600 may include additional operations, fewer operations, and/or different operations than those illustrated in FIGS. 6A and 6B, and described herein. For example, according to other implementations, program agent 125 may determine whether the user has provided a rating. If program agent 125 determines that the user has not provided a rating, then program agent 125 may transmit the view history record to view history element 110-8. Program agent 125 may wait a period of time to allow the user to rate the program before transmitting the view history record. According to an exemplary implementation, program agent 125 prompts the user, via a user interface, to rate the program, or catalog element 110-5 prompts the user. If the user declines to rate the program, program agent 125 transmits the view history record, as previously described. As previously described, however, the view history record may be transmitted even if the user rates the program. For example, view history element 110-8 may use view history records pertaining to programs the user has rated as a comparative to view history records pertaining to programs the user has not rated.

The foregoing description of embodiments provides illustration, but is not intended to be exhaustive or to limit the embodiments to the precise form disclosed. For example, in the preceding specification, various embodiments have been described with reference to the accompanying drawings. However, various modifications and changes may be made thereto, and additional embodiments may be implemented, without departing from the broader scope of the invention as set forth in the claims that follow. The specification and drawings are accordingly to be regarded as illustrative rather than restrictive.

Various embodiments have been described in relation to programs. However, the concepts described herein are equally applicable to other forms of media, such as books, games, songs, etc. For example, in relation to songs, a program agent may generate a listening history record, in which a record identifier identifies the user, a device record identifies the user device, and a trajectory identifier identifies an audio file (e.g., a song, etc.). The listening history record may include normalized audio listening data that includes the date, time, and user listening behavior. Users may rate songs, etc., and proxy ratings may be generated when the users do not rate the songs, etc. The proxy ratings may be generated in a similar manner as described above, including the use of the analytics and heuristics to increment or decrement a proxy rating based on other listening history records pertaining to other audio files (e.g., songs).

Additionally, for books—reading history records may be generated by a program agent monitoring the reading behavior of the user, and for games—playing history records may be generated. These records may form a basis to generate proxy ratings and be used to provide recommendations to users. According to yet another exemplary embodiment, a proxy rating may be used in combination with a rating to generate a recommendation. That is, even if the user assigned a rating to a program or other media, the recommendation engine may use both values. In this way, the user's consumption behavior of the program or other media may be considered when generating a recommendation. According to an exemplary implementation, a weight may be assigned to the proxy rating based on the contrast value.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while a series of blocks has been described with regard to the process illustrated in FIGS. 6A and 6B, the order of the blocks may be modified according to other embodiments. Further, non-dependent blocks may be performed in parallel. Additionally, other processes described in this description may be modified and/or non-dependent operations may be performed in parallel.

The embodiments described herein may be implemented in many different forms of software executed by hardware or hardware. For example, a process or a function may be implemented as “logic” or as a “component.” This logic or this component may include hardware (e.g., processor 505, etc.) or a combination of hardware and software (e.g., software 515). The embodiments have been described without reference to the specific software code since software can be designed to implement the embodiments based on the description herein.

Additionally, embodiments described herein may be implemented as a non-transitory storage medium that stores data and/or information, such as instructions, program code, data structures, program modules, an application, etc. For example, a non-transitory storage medium includes one or more of the storage mediums described in relation to memory/storage 510. The data and/or information may be executed to perform processes or provide functions, as described herein.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

No element, act, or instruction described in the present application should be construed as critical or essential to the embodiments described herein unless explicitly described as such.

What is claimed is:

1. A method comprising:
transmitting a program to a user;
obtaining a user identifier that identifies the user and a program identifier that identifies the program;
generating, by a device, normalized tracking data that indicates a viewing behavior by the user of the program, wherein the normalized tracking data indicates at least a portion of the program viewed by the user according to a normalized time-length metric;
generating, by the device, a view history record based on the user identifier, the program identifier, and the normalized tracking data;
determining whether a rating for the program is received from the user; and
generating a proxy rating based on the view history record, in response to determining that the rating for the program is not received from the user.

2. The method of claim 1, further comprising:
transmitting the view history record to another device, in response to determining that the rating for the program is received from the user; and
using the view history record to generate a proxy rating pertaining to another program for which a rating is not received from the user.

3. The method of claim 1, further comprising:
generating a recommendation of a program for the user based on the proxy rating.

4. The method of claim 1, wherein the generating of the proxy rating comprises:
storing view history records pertaining to other programs viewed by the user;
applying a heuristic to the view history records and the view history record; and
incrementing or decrementing the proxy rating based on the applying.

5. The method of claim 4, wherein the applying comprises:
comparing a viewing behavior represented by the view history records to a viewing behavior represented by the view history record.

6. The method of claim 5, further comprising:
generating a contrast value based on the comparing; and wherein the incrementing or decrementing comprises:
incrementing or decrementing the proxy rating based on the contrast value.

7. The method of claim 4, wherein the applying comprises:
identifying a type of playing event included in the view history record, wherein the play event includes at least one of stop, rewind, fast-forward, or pause; and
identifying a frequency of the playing event included in the view history record.

8. The method of claim 1, wherein the generating of the proxy rating comprises:
applying a weight to each portion of the program, wherein a weight of an ending portion of the program has a greater value than a weight of another portion of the program;
identifying that the view history record indicates that the user viewed the ending portion of the program; and
incrementing the proxy rating based on the identifying.

9. A system comprising:
a user device comprising:
a first transmitter and a first receiver;
a first memory, wherein the first memory stores instructions; and
a first processor, wherein the first processor executes the instructions to:
receive, via the first receiver, a program;
play the program;
obtain a user identifier that identifies the user and a program identifier that identifies the program;
generate normalized tracking data that indicates a viewing behavior of a user relating to a playing of the program, wherein the normalized tracking data indicates at least a portion of the program played by the user according to a normalized time-length metric;
generate a view history record based on the normalized viewing data, the user identifier, and the program identifier;
determine whether a rating for the program is received from the user; and
transmit, via the first transmitter, the view history record to a first network device, in response to a determination that the rating is not received.

10. The system of claim 9, further comprising:
the first network device comprising:
a second transmitter and a second receiver;
a second memory, wherein the second memory stores instructions; and
a second processor, wherein the second processor executes the instructions to:
receive, via the second receiver, the view history record; and
generate a proxy rating based on the view history record.

11. The system of claim 10, wherein the second processor executes the instruction to:
receive, via the second receiver, unrated program information indicating programs to which the user did not assign ratings;
compare the unrated program information to the view history record; and
determine that the user did not assign a rating to the program.

12. The system of claim 10, wherein the second processor executes the instruction to:
store view history records pertaining to other programs viewed by the user;
apply a heuristic to the view history records and the view history record; and
increment or decrement the proxy rating based on an application of the heuristic.

13. The system of claim 12, wherein, when applying the heuristic, the second processor executes the instruction to:
compare a behavior of the user indicated by the view history records pertaining to other programs viewed by the user to a behavior of the user indicated by the view history record.

14. The system of claim 13, wherein the second processor executes the instruction to:
generate a contrast value based on the compare, wherein the contrast value indicates a degree of contrast; and wherein when incrementing or decrementing, the second processor executes the instruction to:
increment or decrement the proxy rating based on the contrast value.

15. The system of claim 12, wherein, when applying the heuristic, the second processor executes the instruction to:
identify a type of playing event included in the view history record, wherein the play event includes at least one of stop, rewind, fast-forward, or pause; and
identify a frequency of the playing event included in the view history record.

16. The system of claim of claim 9, wherein, when generating the proxy rating, the second processor executes the instructions to:
apply a weight to each portion of the program, wherein a weight of an ending portion of the program has a greater value than a weight of another portion of the program;
identify that the view history record indicates that the user viewed the ending portion of the program; and
increment the proxy rating based on the weight applied to the ending portion of the program.

17. The system of claim 10, further comprising:
a second network device comprising:
a third transmitter and a third receiver;
a third memory, wherein the third memory stores instructions; and
a third processor, wherein the third processor executes the instructions to:
receive, via the third receiver, the proxy rating; and
generate a recommendation for one or more other programs based on the proxy rating.

18. A method comprising:
transmitting a media to a user;
obtaining a user identifier that identifies the user and a media identifier that identifies the media;
generating, by a device, normalized tracking data that indicates a behavior by the user during a consumption of the media, wherein the normalized tracking data indicates at least a portion of the media consumed by the user according to a normalized metric;
generating, by the device, a history record based on the user identifier, the media identifier, and the normalized tracking data;
determining whether a rating for the media is received from the user; and
generating a proxy rating based on the history record, in response to determining that the rating for the media is not received from the user.

19. The method of claim 18, wherein the media comprises a book, a song, or a game, and the proxy rating indicates a degree of interest in the media by the user.

20. The method of claim 18, further comprising:
generating a recommendation of another media for the user based on the proxy rating.
